(19) United States
(12) Patent Application Publication
(10) Pub. No.: US 2005/0006295 A1
(43) Pub. Date: Jan. 13, 2005

(54) Water treatment system

(76) Inventor: Upen Bharwada, Midland, MI (US)

Correspondence Address: ANDREW ALEXANDER & ASSOCIATES, 3124 KIPP AVENUE, P.O. BOX 2038, LOWER BURRELL, PA, 15068, US

(21) Appl. No.: 10/773,887

(22) Filed: Feb. 6, 2004

Related U.S. Application Data
(60) Provisional application No. 60/446,160, filed on Feb. 10, 2003.
(60) Provisional application No. 60/446,528, filed on Feb. 11, 2003.

(51) Int. Cl. B01D 63/00

(52) U.S. Cl. 210/321.6

(57) ABSTRACT

In some aspects, the invention provides an apparatus for treating water that has an MF or UF membrane filter located upstream of a downstream reverse osmosis unit. The MF or UF filter provides pretreatment for the RO unit. The feed water to be treated is fed to the MF or UF filter. Permeate from the MF or UF filter is fed to the reverse osmosis unit. The RO unit is thus fed with pre-treated water having a reliably and significantly reduced concentration of suspended solids. Spacers in the RO unit are made thinner than spacers that would be appropriate for use if the RO unit was fed with the water to be treated directly or through a less reliable pretreatment stage. For example, the RO spacers of a spiral wound module may be 15 to 25 mil (381 to 635 microns) thick or 17 to 22 mil (431.8 to 558.8 microns) thick.

### CROSS REFERENCE TO RELATED APPLICATION

This application claims the benefit of U.S. Provisional Application Nos. 60/446,160, filed Feb. 10, 2003, and 60/446,528, filed Feb. 11, 2003, incorporated herein by reference.

### FIELD OF THE INVENTION

This invention relates to water treatment systems and processes. In particular, the invention relates to a system having both an MF or UF membrane filter and a reverse osmosis unit.

### BACKGROUND OF THE INVENTION

Reverse osmosis modules are described, for example, in U.S. Pat. Nos. 3,367,504; 3,827,564; and, 4,235,723. MF or UF membrane filters are described for example in U.S. Pat. No. 6,325,928. Water treatment systems are described, for example, in U.S. Pat. Nos. 5,250,182; 5,454,952; 5,501,798; and, 5,585,531. All of the patents mentioned above are incorporated into this document by this reference to them as if those patents were set out in their entirety in this document.

### SUMMARY OF THE INVENTION

It is an object of the invention to provide a water treatment system and process. It is another object of the invention to improve on the prior art.

In some aspects, the invention provides an apparatus for treating water that has a microfiltration (“MF”) or ultrafiltration (“UF”) membrane filter located upstream of a downstream reverse osmosis (“RO”) unit. The MF or UF filter provides pretreatment for the RO unit. The feed water to be treated is fed to the MF or UF filter. Permeate from the MF or UF filter is fed to the reverse osmosis unit. The RO unit is thus fed with pre-treated water having a reliably and significantly reduced concentration of suspended solids. Spacers in the RO unit are made thinner than spacers that would be appropriate for use if the RO unit was fed with the water to be treated directly or through a less reliable pretreatment stage. For example, the RO spacers of a spiral wound module may be 15 to 25 mil (381 to 635 microns) thick or 17 to 22 mil (431.8-558.8 microns) thick.

In other aspects, the invention provides a system as described above using an immersed membrane filter and a spiral wound RO module.

In other aspects, the invention provides a process or apparatus for desalinating seawater. The spacers may then be brine channel spacers (“BCS”).

The summary above is intended to introduce the reader to the invention or inventions. The invention(s) may consist of one or more combinations or sub-combinations of the steps or elements described above or in the remainder of this document.

### BRIEF DESCRIPTION OF THE DRAWINGS

Embodiments of the invention will be described below with reference to the following figures:

FIG. 1 is a schematic representation of a first embodiment.

### DETAILED DESCRIPTION OF EMBODIMENTS

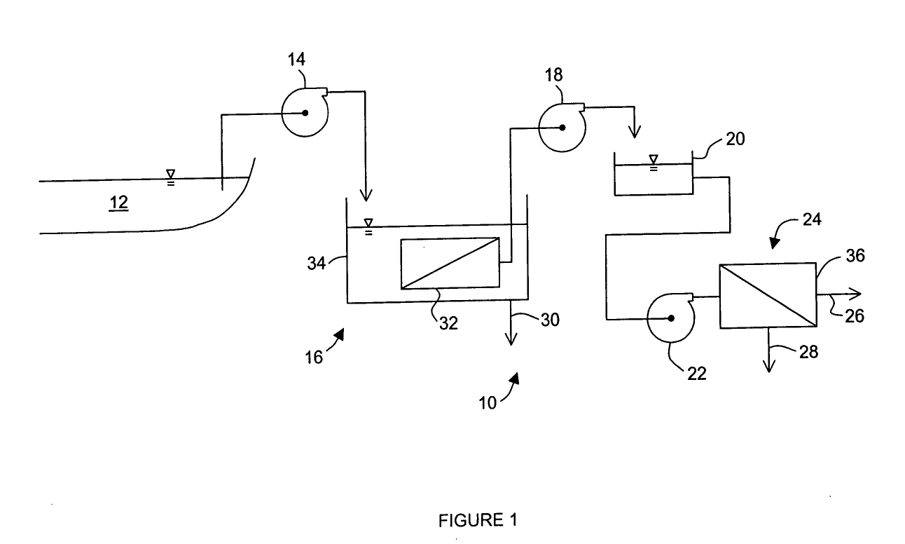

FIG. 1 shows a water treatment system 10 used to treat a feed water 12. The feed water 12 is fed by a feed pump 14 into an MF or UF membrane filtration system 16. Permeate is withdrawn from the MF or UF system 16 by a permeate pump 18 to a transfer tank 20. Water in the transfer tank 20 is pressurized by an RO feed pump 22 and fed to an RO system 24. RO permeate 26 and RO retentate 28 are removed from the RO system 24. MF or UF retentate 30 is removed from the MF or UF system 16.

The MF or UF system 16 may be an immersed membrane filtration system having one or more MF or UF module(s) 32 submerged in a tank 34 exposed to atmospheric pressure. The MF or UF module(s) 32 may be hollow fibre membrane modules. Backwashing, tank draining, aeration, chemical cleaning, integrity testing and other appropriate ancillary systems are also provided as known in the art. The MF or UF module(s) 32 provide reliable and significant reduction in the concentration of suspended solids and other contaminants such that the MF or UF permeate supplied to the RO system 24 is highly filterable.

The RO system 24 includes one or more RO modules 36 which may be spiral wound modules. Methods of making these and other suitable modules are known in a general sense in the art. However, the RO module(s) 36 have thin spacers separating sheets of RO membrane material. Because of the reliably contaminant reduced feed to the RO system 24, the spacers in the RO modules 36 may be thinner than spacers that would be used if the RO system 24 were fed with the feed water 12 directly or with feed water pretreated through less reliable pretreatment systems. Backwashing, tank draining, chemical cleaning, integrity testing and other appropriate ancillary systems are provided for the RO system 24 as known in the art.

### EXAMPLE

A seawater desalination plant has a screened but otherwise open intake to an ocean. The feed taken in though the intake has contaminant loadings and salinity that vary with tide, wind, rain and other conditions.

The feed is first treated with an immersed hollow fiber UF system having ZEEWEED 1000 modules made by Zenon Environmental Inc. The ZEEWEED 1000 system always provides an SDI of less than 3 and provides an SDI between 1.5 and 2.5 over 90% of time. Permeate turbidity is always less than 0.15 NTU and is less than 0.1 NTU over 95% of the time. The ZEEWEED 1000 system also provides 4 log removal of bacteria and cysts and substantial TOC and biofoulants removal. Silt, colloids, bacteria, colloidal silica, organic molecules, corrosion products and other contaminants are all substantially removed. The permeate is much less variable than the raw feed water. Pretreatment cartridge filters are not used.

The permeate is fed to a set of custom made reverse osmosis modules. The modules have a configuration similar to FILMTEC SWHR 380 modules made by Dow. However, whereas the SWHR 380 modules have 30 leaves of about 12.5 square feet per leaf, the modules of the present example have 38 leaves of about 12.5 square feet per leaf each in a module of the same size (8 inch by 40 inch). Space for the additional leaves is provided by using 20 mil (508 microns) BCS spacers rather than the 28 mil (711.2 microns) spacers used in the SWHR 380 modules. Productivity of the new module is 7500 GPD at about 16 GFD compared to about 6000 GPD at about 16 GFD for the SWHR 380 modules. Despite the increase in surface area, the new module has a larger annulus (compared to an SWHR 380 module) between the outside of the membrane elements and the inside of the pressure vessel. This results in reduced dead end areas in the annulus which inhibits biological fouling. The new modules permit a 25% reduction in the number of modules required for the same flow per day. The number or amount of pumps, pipes, racks and other equipment related to the number of modules is also reduced. Chemical cleaning frequency of the new modules was also reduced compared to the SWHR 380 modules.

The descriptions above are of exemplary embodiments only and the invention may be practiced in many other ways. For example, a BW (brackish water) RO module with 26 to 28 mil (660.4 to 711.2 microns) BCS (brine channel spacer) can be replaced with an 18 to 22 mil (457.2 to 558.8 microns) thickness spacer to increase the number of leaves and therefore available surface area by as much as 25% and concomitant product water (permeate) flow per element. Such a module may be used to treat a primary or secondary wastewater (sewage or industrial) effluent that has been treated by a Membrane bioreactor (MBR) such as ZEEWEED ZENOGEM system by Zenon Environmental Inc. The permeate from this MBR would have an SDI of below 3.0 always and between 1.5 to 2.5 95% of the time while turbidity would be below 0.25 NTU 100% of the time and free oil below 3 ppm. The MBR would also remove substantially all of the biodegradable COD leaving essentially only the non-biodegradable COD as a feed to RO. Under these conditions, a downstream brackish water (BW) or Nanofiltration (NF) spiral wound element (to remove TDS) can be constructed and used in combination with an MF or UF pretreatment stage according to the invention.

### Having thus described the invention, what is claimed is:

1. An apparatus for treating water comprising, an MF or UF membrane filter and a reverse osmosis unit wherein water to be treated is fed into the MF or UF membrane filter, permeate from the membrane filter is fed to the reverse osmosis unit and spacers in the reverse osmosis unit are thinner than spacers appropriate for use in a reverse osmosis unit which is fed directly with the water to be treated.

2. An apparatus for treating water having an MF or UF membrane filter providing pretreatment of feed water for a downstream reverse osmosis unit wherein the reverse osmosis unit has spacers between 15 and 25 mil (381 and 635 microns) thick.

3. The apparatus of claim 2 wherein the spacers are between 17 and 22 mil (431.8 and 558.8 microns) thick.

4. The apparatus of any of claims 1 to 3 wherein the MF or UF membrane filter is a suction driven immersed membrane filter.

5. The apparatus of any of claims 1 to 4 wherein the reverse osmosis unit is a spiral wound module.

6. The apparatus of any of claims 1 to 5 used to desalinate salt water.

7. The apparatus of any of claims 1 to 5 wherein the feed water is salt water.
